(19) United States
(12) Patent Application Publication
(10) Pub. No.: US 2018/0265004 A1
(43) Pub. Date: Sep. 20, 2018

(54) VEHICLE PERIPHERY IMAGE DISPLAY DEVICE

(71) Applicant: MAZDA MOTOR CORPORATION, Aki-gun, Hiroshima (JP)

(72) Inventors: Tsuneo Kudou, Hiroshima-shi, Hiroshima (JP); Hideki Kobamba, Hiroshima-shi, Hiroshima (JP)

(21) Appl. No.: 15/761,070

(22) PCT Filed: Feb. 15, 2017
(86) PCT No.: PCT/JP2017/005534

§ 371 Date: Mar. 16, 2018

(30) Foreign Application Priority Data
Mar. 7, 2016 (JP) 2016-043762

(51) Int. Cl. B60R 1/00; G08G 1/16; H04N 7/18

(52) U.S. Cl. CPC B60R 1/002; G08G 1/167; B60R 2300/50; B60R 2300/802; H04N 7/18

(57) ABSTRACT

In the vehicle periphery image display device, an own vehicle periphery image is displayed around an own vehicle overview image and, when an obstacle is detected in an own vehicle periphery, an obstacle indicating section indicating a detected location of the obstacle around the own vehicle and a distance between an own vehicle and the obstacle is displayed closer to the own vehicle overview image than the own vehicle periphery image.

### TECHNICAL FIELD

The present invention relates to a vehicle periphery image display device that displays on a display screen an own vehicle periphery image in a situation such as when parking the vehicle.

### BACKGROUND ART

A vehicle such as an automobile is usually equipped with a vehicle periphery image display device that displays on a display screen, such as a display provided inside a vehicle interior, an own vehicle periphery image captured by an onboard camera to allow a driver to recognize an own vehicle periphery which cannot directly and visually be recognized by the driver from the own vehicle periphery image displayed on the display screen in a situation such as when parking the vehicle.

Among such vehicle periphery image display devices, a vehicle periphery image display device has also been known that displays on a display screen provided inside a vehicle interior the location and distance of an obstacle detected in the own vehicle periphery an onboard radar sensor, in addition to displaying the own vehicle periphery image.

For example, PTL 1 discloses a vehicle periphery image display device that displays on a display screen an own vehicle periphery image and, when an obstacle is detected in an own vehicle periphery, a distance indicating line that indicates a distance between an own vehicle and the obstacle. The vehicle periphery image display device enables recognizing the distance of the obstacle by the distance indicating line.

### CITATION LIST

### Patent Literature

PTL 1: JP 2010-184604 A

### SUMMARY OF INVENTION

### Technical Problem

However, the vehicle periphery image display device described in PTL 1 displays, when an obstacle is detected in an own vehicle periphery, the distance indicating line that indicates the distance between the own vehicle and the obstacle superposed on the own vehicle periphery image, so that it may be difficult to see the own vehicle periphery image on the display screen, and visibility of the obstacle may be deteriorated.

An object of the present invention is to provide a vehicle periphery image display device that can accurately display the location and distance of an obstacle without deteriorating visibility of the obstacle in an own vehicle periphery image.

### Solution to Problem

To solve the abovementioned problem, a vehicle periphery image display device according to the present invention is configured as described below.

A first invention of the present application is a vehicle periphery image display device that displays on a display screen own vehicle an own vehicle periphery image, including an image capturing unit that captures an own vehicle periphery image; a display controller that causes the display screen to display an own vehicle overview image, and also to display around the own vehicle overview image the own vehicle periphery image that is captured by the image capturing unit; and an obstacle detector that detects an obstacle in the own vehicle periphery as well as a detected location of the obstacle around the own vehicle and a distance between the own vehicle and the obstacle, in which the display controller displays around the own vehicle overview image the own vehicle periphery image and displays, when the obstacle detector detects an obstacle in the own vehicle periphery, an obstacle indicating section closer to the own vehicle overview image than the own vehicle periphery image, the obstacle indicating section indicating the detected location of the obstacle around the own vehicle and the distance between the own vehicle and the obstacle.

A second invention is characterized in that in the vehicle periphery image display device according to the first invention, the obstacle indicating section is an obstacle indicating line provided along around the own vehicle overview image, and the display controller changes a displaying mode of the obstacle indicating section according to the distance between the own vehicle and the obstacle.

A third invention is characterized in that in the vehicle periphery image display device according to the second invention, the display controller displays the own vehicle periphery image around the own vehicle overview image with a blind area which is not included in the own vehicle periphery image captured by the image capturing unit between the own vehicle overview image and the own vehicle periphery image, and also displays the obstacle indicating line in the blind area along around the own vehicle overview image.

A fourth invention is characterized in that in the vehicle periphery image display device according to the second invention, the display controller displays in the own vehicle overview image the obstacle indicating line along around the own vehicle overview image.

A fifth invention is characterized in that in the vehicle periphery image display device according to any one of the second to fourth inventions, the display controller changes the displaying mode of the obstacle indicating line according to the distance between the own vehicle and the obstacle by changing at least one of a line type, a displaying color, and a mode of lighting or blinking of the obstacle indicating line.

A sixth invention is characterized in that in the vehicle periphery image display device according to the fifth invention, when the displaying mode of the obstacle indicating line is changed by changing the mode of lighting or blinking of the obstacle indicating line according to the distance between the own vehicle and the obstacle, the display controller changes a blinking frequency of the obstacle indicating line according to the distance between the own vehicle and the obstacle.

A seventh invention is characterized in that in the vehicle periphery image display device according to any one of the first to sixth inventions, the display controller displays the own vehicle periphery image around the own vehicle overview image when parking the vehicle.

### Advantageous Effects of Invention

According to the first invention of the present application, the own vehicle periphery image is displayed around the own vehicle overview image and, when the obstacle is detected in the own vehicle periphery, the obstacle indicating section indicating the detected location of the obstacle around the own vehicle and the distance between the own vehicle and the obstacle is displayed closer to the own vehicle overview image than the own vehicle periphery image. Accordingly, the obstacle indicating section is not superposed on the own vehicle periphery image, so that the obstacle indicating section can accurately display the position and distance of the obstacle without deteriorating the visibility of the obstacle in the own vehicle periphery image. In a situation such as when parking the vehicle, the driver can be given an accurate alert against the obstacle in the own vehicle periphery by the own vehicle periphery image and the obstacle indicating section.

According to the second invention, the obstacle indicating section is an obstacle indicating line provided along around the own vehicle overview image. The displaying mode of the obstacle indicating line is changed according to the distance between the own vehicle and the obstacle, so that a displaying region of the obstacle indicating line can be provided smaller than the case of providing a plurality of the obstacle indicating lines outside of the own vehicle overview image according to the distance between the own vehicle and the obstacle.

Furthermore, according to the third invention, the own vehicle periphery image is displayed around the own vehicle overview image with a blind area which is not included in the vehicle periphery image between the own vehicle overview image and the own vehicle periphery image, and also the obstacle indicating line is displayed in the blind area in a manner of effectively using the blind area which is not included in the own vehicle periphery image as the obstacle indicating section to specifically obtain the effect described above without deteriorating the visibility of the obstacle in the own vehicle periphery image.

Furthermore, according to the fourth invention, with the obstacle indicating line displayed in the vehicle overview image along around the own vehicle overview image, the effect described above can be specifically obtained without deteriorating the visibility of the obstacle in the own vehicle periphery image.

Furthermore, according to the fifth invention, the displaying mode of the obstacle indicating line can be changed according to the distance between the own vehicle and the obstacle by changing at least one of the line type, the displaying color, and the mode of lighting or blinking of the obstacle indicating line, thereby indicating the distance between the own vehicle and the obstacle in a relatively easy manner.

Furthermore, according to the sixth invention, when the displaying mode of the obstacle indicating line is changed according to the distance between the own vehicle and the obstacle by changing the mode of lighting or blinking of the obstacle indicating line, the blinking frequency of the obstacle indicating line is changed according to the distance between the own vehicle and the obstacle so that the driver can easily recognize the distance between the own vehicle and the obstacle.

Furthermore, according to the seventh invention, with the own vehicle periphery image displayed around the own vehicle overview image when parking the vehicle, the driver is given an accurate alert against the obstacle in the own vehicle periphery by the own vehicle periphery image and the obstacle indicating section when parking the vehicle. This effectively supports the driver to park the vehicle.

### BRIEF DESCRIPTION OF DRAWINGS

FIG. 1 is a control system diagram of a vehicle periphery image display device according to an embodiment of the present invention.

FIG. 2 is a schematic diagram illustrating arrangement of a camera and a radar sensor of the vehicle periphery image display device.

FIG. 3 is an explanatory view for explaining a display of a vehicle periphery image display device according to a first embodiment.

FIG. 4 is a flowchart illustrating display control of the vehicle periphery image display device.

FIG. 5 is a flowchart illustrating display control of an obstacle.

FIG. 6 is an explanatory view for explaining a display of a vehicle periphery image display device according to a second embodiment.

### DESCRIPTION OF EMBODIMENTS

Embodiments of the present invention will be described below with reference to the drawings.

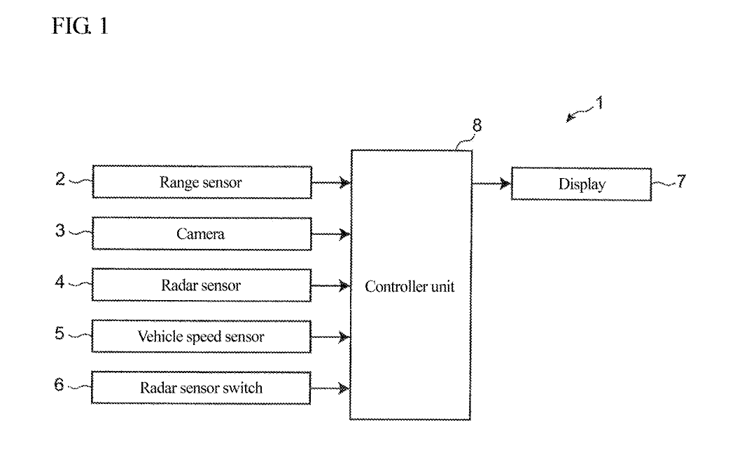

FIG. 1 is a control system diagram of a vehicle periphery image display device according to an embodiment of the present invention. A vehicle periphery image display device 1 according to an embodiment of the present invention is mounted on a vehicle, such as an automobile, and includes a range sensor 2 that detects a shift lever range selected by a driver, namely, P (parking) range, R (backward driving) range, N (neutral) range, and D (forward driving) range, a camera 3 such as a wide angle camera serving as an image capturing unit to capture an own vehicle periphery image, a radar sensor 4 such as an ultrasonic radar sensor serving as a detector that detects an obstacle in an own vehicle periphery as well as a detected location of the obstacle around an own vehicle and a distance between the own vehicle and the obstacle, a vehicle speed sensor 5 that detects a speed of the vehicle, a radar sensor switch 6 that starts display control of displaying the vehicle periphery image and an obstacle indicating section, which will be described later, when the obstacle is detected in the own vehicle periphery, and a display 7 serving as a display screen.

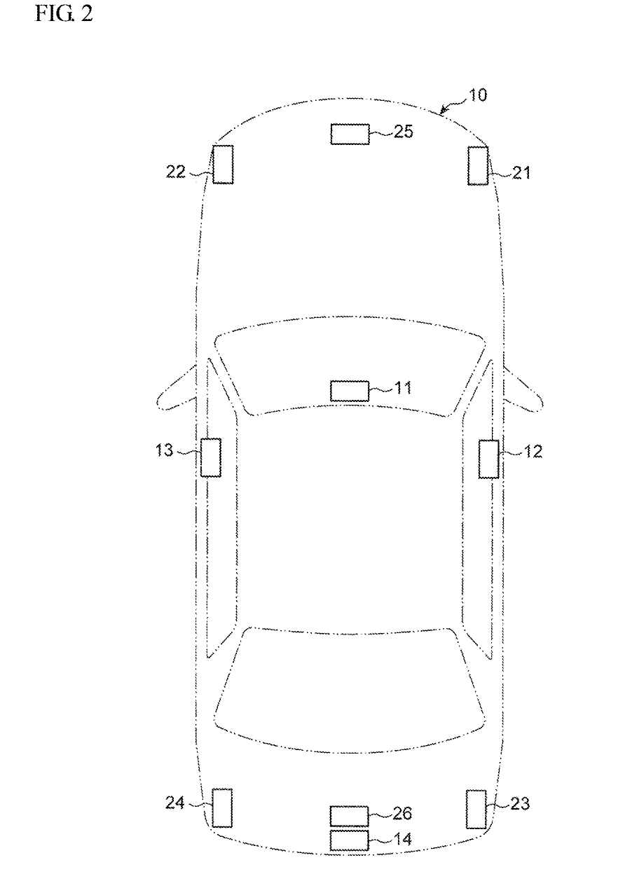

FIG. 2 is a schematic diagram illustrating arrangement of the camera and the radar sensor of the vehicle periphery image display device. As shown in FIG. 2, the camera 3 mounted on the vehicle 10 specifically includes a front camera 11 disposed in the front part of the vehicle body to capture an image of the forward side of the own vehicle, a right side camera 12 disposed in the right side part of the vehicle body to capture an image of the right side of the own vehicle, a left side camera 13 disposed in the left side part of the vehicle body to capture an image of the left side of the own vehicle, and a rear camera 14 disposed in the rear part of the vehicle body to capture an image of the rear side of the own vehicle.

Specifically, the radar sensor 4 mounted on the vehicle 10 includes a right front corner sensor 21 disposed at the right front corner of the vehicle body to detect an obstacle in the right front corner periphery of the own vehicle, a left front corner sensor 22 disposed at the left front corner of the vehicle body to detect an obstacle in the left front corner periphery of the own vehicle, a right rear corner sensor 23 disposed at the right rear corner of the vehicle body to detect an obstacle in the right rear corner periphery of the own vehicle, a left rear corner sensor 24 disposed at the left rear corner of the vehicle body to detect an obstacle in the left rear corner periphery of the own vehicle, a front sensor 25 disposed in the front of the vehicle body to detect an obstacle in the front periphery of the own vehicle, and a rear sensor 26 disposed in the rear of the vehicle body to detect an obstacle in the rear periphery of the own vehicle. When each of the sensors 21 to 26 detects an obstacle, the position of the obstacle and the distance between the own vehicle and the obstacle can be detected.

The display 7 in the vehicle periphery image display device 1 is installed in the middle portion of a dash panel of the vehicle body in the vehicle interior. The display 7 displays route information for the vehicle and, in a situation such as when parking the vehicle, the image of the rear side of the own vehicle captured by the rear camera 14.

As shown in FIG. 1, the vehicle periphery image display device 1 also includes a controller unit 8 that controls for example the display 7. The controller unit 8 performs control of an image to be displayed on the display 7 based on a signal input from the range sensor 2, the camera 3, the radar sensor 4, the vehicle speed sensor 5, and the radar sensor switch 6. The controller unit 8 includes a microcomputer as a main unit.

The controller unit 8 can also display on the display 7 the own vehicle overview image and the own vehicle periphery image based on a signal from the camera 3, and can also display on the display 7 the position and distance of the obstacle in the own vehicle periphery based on a signal from the radar sensor 4.

In the present embodiment, the controller unit 8 causes the display 7 to display the own vehicle periphery image around the own vehicle overview image when the range sensor 2 detects the backward driving range in a situation such as when parking the vehicle, and performs obstacle indication control to display, closer to the own vehicle overview image than the own vehicle periphery image, the obstacle indicating section indicating the detected location of an obstacle around the own vehicle and the distance between the own vehicle and the obstacle when the obstacle is detected in the vehicle periphery. The own vehicle overview image is previously stored in the controller unit 8.

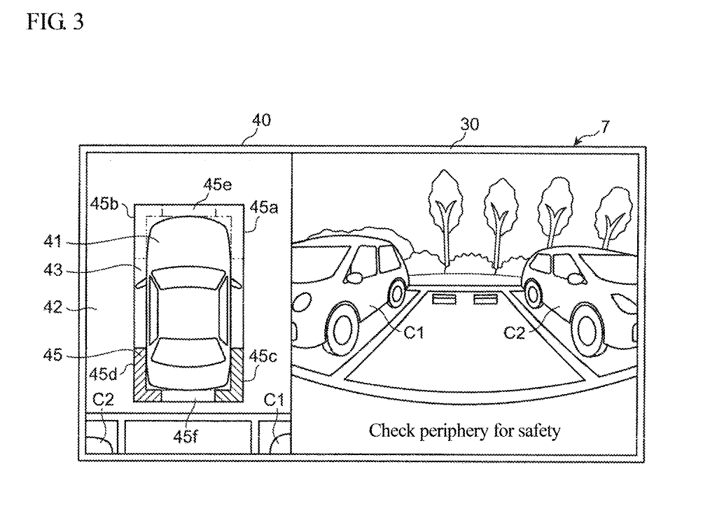

FIG. 3 is an explanatory view for explaining the display of the vehicle periphery image display device according to the first embodiment. As shown in FIG. 3, when the range sensor 2 detects the backward driving range, the display 7 displays two screens, one in right and the other in left. On a right screen 30, the image of the rear side of the own vehicle captured by the rear camera 14 is displayed. On a left screen 40, an own vehicle overview image 41 is displayed together with an own vehicle periphery image 42 around the own vehicle overview image 41.

On the left screen 40, the own vehicle periphery image 42 is displayed around the own vehicle overview image 41 with a blind area 43 which is not included in the own vehicle periphery image captured by the camera 3 between the own vehicle overview image 41 and the own vehicle periphery image 42. Also, on the left screen 40, an obstacle indicating line 45 is displayed in the blind area 43 which is closer to the own vehicle overview image than the own vehicle periphery image 42 around the own vehicle, along around the own vehicle overview image 41, where the obstacle indicating line 45 is displayed as an obstacle indicating section indicating the position and the distance of the obstacle.

The obstacle indicating line 45 specifically includes a right front corner obstacle indicating line 45a, a left front corner obstacle indicating line 45b, a right rear corner obstacle indicating line 45c, and a left rear corner obstacle indicating line 45d, each of which is provided at the right front corner, the left front corner, the right rear corner, and the left rear corner around the own vehicle overview image 41, and also includes a front center obstacle indicating line 45e and a rear center obstacle indicating line 45f, each of which is provided at the front center and the rear center around the own vehicle overview image 41.

When an obstacle is detected in the own vehicle periphery based on a signal from the radar sensor 4, an obstacle indicating line, among the obstacle indicating lines 45a to 45f constituting the obstacle indicating line 45, that corresponds to the location of the obstacle around the own vehicle detected by the radar sensor 4 is displayed. The distance between the own vehicle and the obstacle detected by the radar sensor 4 is displayed by changing the displaying mode of the obstacle indicating line 45 (each of the obstacle indicating lines 45a to 45f).

The obstacle indicating line 45 performs changing at least the line type, the displaying color, and the mode of lighting or blinking according to the distance between the own vehicle and the obstacle. Furthermore, when blinking the obstacle indicating line 45, the blinking frequency of the obstacle indicating line 45 can be changed according to the distance between the own vehicle and the obstacle.

For the obstacle indicating line 45 displayed on the display 7 in the vehicle periphery image display device according to the first embodiment, Table 1 below shows displaying modes that are changed according to the distance between the own vehicle and the obstacle. In Table 1, the right front corner obstacle indicating line 45a, the left front corner obstacle indicating line 45b, the right rear corner obstacle indicating line 45c, and the left rear corner obstacle indicating line 45d are each expressed as a corner, the front center obstacle indicating line 45e is expressed as a front center, and the rear center obstacle indicating line 45f is expressed as a rear center.

TABLE 1

| Ranges in which | | | | | | | | |
|---|---|---|---|---|---|---|---|---|
| obstacle is | | | | | | | Displaying color, | Lighting or |
| detected | Corner | | Front center | | Rear center | | line type | blinking |
| Short range | About 30 | cm | About 30 | cm | About 30 | cm | Red solid line | Blinking |
| | | | | | | | | 5 Hz |
| Middle range | 30 to 45 | cm | 30 to 50 | cm | 30 to 50 | cm | Orange solid line | Blinking |
| | | | | | | | | 2 to 3 Hz |
| Long range | 45 to 55 | cm | 50 to 80 | cm | 50 to 80 | cm | Yellow solid line | Lighting |
| Far-long range | | | 80 to 100 | cm | 80 to 150 | cm | Green solid line | Lighting |

As shown in Table 1, in the present embodiment, the obstacle indicating line 45 indicates the distance from the obstacle by ranges in which the obstacle is detected, which are a short range, a middle range, a long range, and a far-long range. The obstacle indicating line 45 is displayed as a red solid line blinking at a frequency of 5 Hz when the obstacle is detected in the short range, an orange solid line blinking at a frequency of 2 to 3 Hz when the obstacle is detected in the middle range, an yellow solid line blinking when the obstacle is detected in the long range, and a green solid line blinking when the obstacle is detected in the far-long range.

As for the corner obstacle indicating lines 45a, 45b, 45c, and 45d, the short range is set to a distance shorter than 30 cm, the middle range is set to a distance of 30 cm or longer and shorter than 45 cm, and the long range is set to a distance of 45 cm or longer and shorter than 55 cm. As for the front center obstacle indicating line 45e, the short range is set to a distance shorter than 30 cm, the middle range is set to a distance of 30 cm or longer and shorter than 50 cm, the long range is set to a distance of 50 cm or longer and shorter than 80 cm, and the far-long range is set to a distance of 80 cm or longer and shorter than 100 cm. As for the rear center obstacle indicating line 45f, the short range is set to a distance shorter than 30 cm, the middle range is set to a distance of 30 cm or longer and shorter than 50 cm, the long range is set to a distance of 50 cm or longer and shorter than 80 cm, and the far-long range is set to a distance of 80 cm or longer and shorter than 150 cm.

As shown in FIG. 3, when vehicles C1 and C2 are respectively present at a distance of 50 cm from the own vehicle in the right rear corner periphery and left rear corner periphery of the own vehicle when parking the vehicle, the corner obstacle indicating lines 45c and 45d are each displayed as a blinking yellow solid line on the left screen 40 according to the location and distance of the vehicles C1 and C2 (in FIG. 3, the diagonally hatched lines indicate the blinking yellow solid lines).

As shown in Table 1, the displaying mode of the obstacle indicating line 45 to be displayed corresponding to the location and distance of the obstacle in the own vehicle periphery is preset and stored in the controller unit 8.

In a case where an ON signal is input from the radar sensor switch 6 by an operator with pushing the radar sensor switch 6 and a vehicle speed detected by the vehicle speed sensor 5 is below a predetermined vehicle speed, for example 20 km/h, the controller unit 8 causes the display 7 to display the own vehicle periphery image around the own vehicle overview image even when the range sensor 2 detects a range other than the backward driving range, and performs obstacle indication control to display, closer to the own vehicle overview image than the own vehicle periphery image, the obstacle indicating section indicating the detected location of an obstacle around the own vehicle and the distance between the own vehicle and the obstacle when the obstacle is detected in the vehicle periphery.

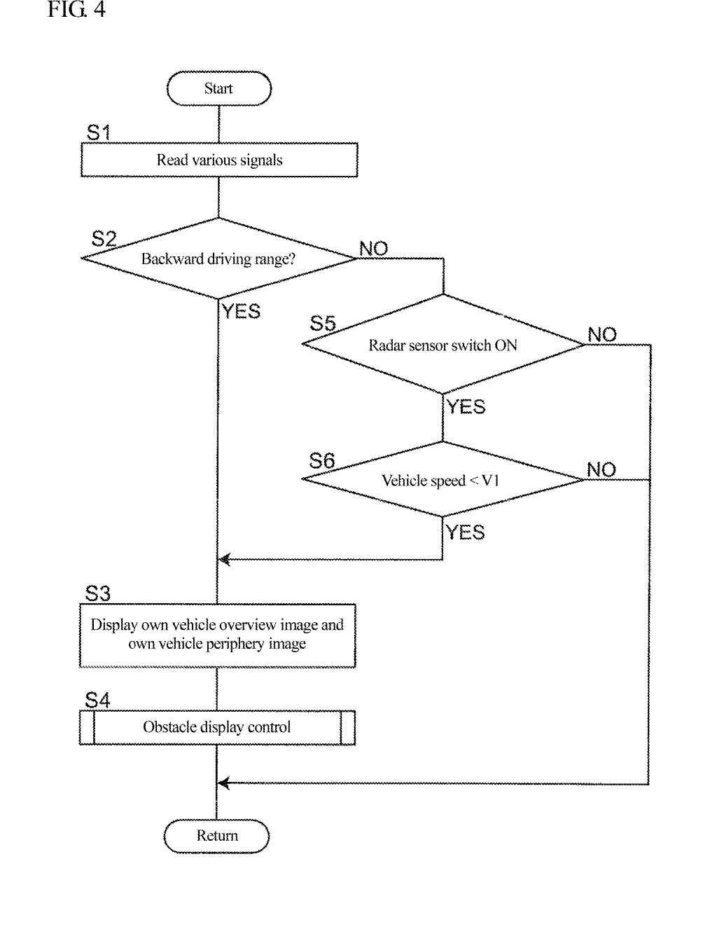

FIG. 4 is a flowchart illustrating the display control of the vehicle periphery image display device. The controller unit 8 performs the display control of the vehicle periphery image display device 1 to display on the display 7 the own vehicle periphery image around the own vehicle overview image and, when an obstacle is detected in the own vehicle periphery, to display the obstacle indicating section.

In the vehicle periphery image display device 1 as shown in FIG. 4, various types of signals related to the vehicle periphery image display device 1 are first read (step S1), and then signals from the range sensor 2, the camera 3, the radar sensor 4, the vehicle speed sensor 5, the radar sensor switch 6 and the like are read.

Then, it is determined whether the shift lever is in the backward driving range (step S2). If the determination in step S2 is YES, that is, if the shift lever is in the backward driving range, the controller unit 8 causes the display 7 to display the own vehicle overview image together with the own vehicle periphery image around the own vehicle overview image (step S3).

When an obstacle is detected in the own vehicle periphery, the controller unit 8 performs the obstacle indication control to display, closer to the own vehicle overview image than the own vehicle periphery image, the obstacle indicating section indicating the detected location of the obstacle around the own vehicle and the distance between the own vehicle and the obstacle with the obstacle indicating section (step S4).

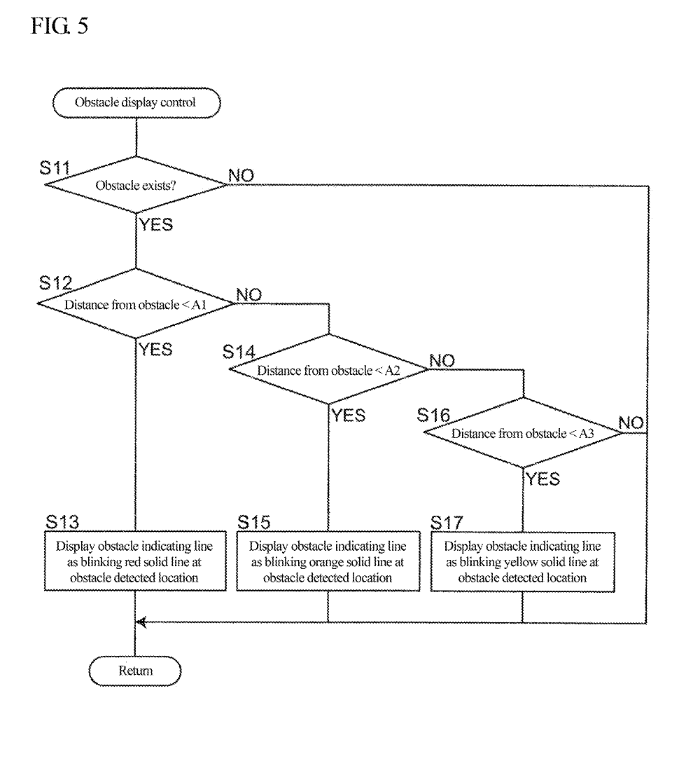

FIG. 5 is a flowchart illustrating display control of an obstacle. FIG. 5 shows an obstacle indication control in which the right rear corner obstacle indicating line 45c is displayed when an obstacle is detected in the right rear corner periphery of the own vehicle based on a signal from the right rear corner sensor 23.

As shown in FIG. 5, it is determined whether there exists an obstacle in the own vehicle periphery (step S11). It is determined whether there exists an obstacle in the right rear corner periphery of the own vehicle based on a signal from the radar sensor 4, specifically the right rear corner sensor 23.

If the determination in step S11 is YES, that is, if it is determined that there exists an obstacle in the own vehicle periphery, the detected location of the obstacle around the own vehicle is the right rear corner based on the signal from the right rear corner sensor 23, and the obstacle indicating line is displayed on the detected location around the own vehicle according to the distance of the obstacle.

If the determination in step S11 is YES, it is determined whether the distance between the own vehicle and the obstacle is shorter than A1 (step S12), namely, it is determined whether the range in which the obstacle is detected is the short range. A1 for the region in the right rear corner periphery of the own vehicle is 30 cm.

If the determination in step S12 is YES, it is determined that the obstacle exists in the short range, and the corner obstacle indicating line 45c corresponding to the detected location of the obstacle is displayed as a red solid line blinking at a frequency of 5 Hz (step S13).

If the determination in step S12 is NO, it is determined whether the distance between the own vehicle and the obstacle is shorter than A2 (step S14), namely, it is determined whether the range in which the obstacle is detected is the middle range. A2 for the region in the right rear corner periphery of the own vehicle is 45 cm.

If the determination in step S14 is YES, it is determined that the obstacle exists in the middle range, and the corner obstacle indicating line 45c corresponding to the detected location of the obstacle is displayed as an orange solid line blinking at a frequency of 2 to 3 Hz (step S15).

If the determination in step S14 is NO, it is determined whether the distance between the own vehicle and the obstacle is shorter than A3 (step S16), namely, it is determined whether the range in which the obstacle is detected is the long range. A3 for the region in the right rear corner periphery of the own vehicle is 55 cm.

If the determination in step S16 is YES, it is determined that the obstacle exists in the long range, and the corner obstacle indicating line 45c is displayed as an yellow line blinking, which corresponds to the detected location of the obstacle (step S17). If the determination in step S16 is NO, it is determined that the obstacle does not exist in the long range, and the controller unit 8 controls the display 7 not to display the corner obstacle indicating line 45c corresponding to the detected location of the obstacle. Also, if the determination in step S11 is NO, the controller unit 8 controls the display 7 not to display the corner obstacle indicating line 45c.

FIG. 5 shows the obstacle indication control in which the right rear corner obstacle indicating line 45c is displayed based on the signal from the right rear corner sensor 23 when an obstacle is detected in the right rear corner periphery of the own vehicle; however, the obstacle indication control to display the right front corner obstacle indicating line 45a, the left front corner obstacle indicating line 45b, and the left rear corner obstacle indicating line 45d based on respective signals from the right front corner sensor 21, the left front corner sensor 22, and the left rear corner sensor 24 is performed in the same manner as above.

The obstacle indication control to display the front center obstacle indicating line 45e and the rear center obstacle indicating line 45f based on respective signals from the front sensor 25 and the rear sensor 26 is performed in the same manner as the obstacle indication control to display the right rear corner obstacle indicating line 45c except that, if the determination in step S16 is NO and further it is determined whether the distance between the own vehicle and the obstacle is shorter than A4, namely, it is determined whether the range in which the obstacle is detected is in the far-long range, and it is determined that the obstacle exists in the far-long range, the obstacle indicating lines 45e and 45f corresponding to the detected distance of the obstacle are displayed as blinking green solid lines.

For the front part periphery of the own vehicle, A1, A2, A3, and A4 are set respectively to 30 cm, 50 cm, 80 cm, and 100 cm. For the rear part periphery of the own vehicle, A1, A2, A3 and A4 are set respectively to 30 cm, 50 cm, 80 cm, and 150 cm.

If the determination in step S2 is NO, that is, if the shift lever is not in the backward driving range, it is determined whether the radar sensor switch 6 is ON, namely, it is determined whether an ON signal is input from the radar sensor switch 6 by an operator with pushing the radar sensor switch 6 (step S5).

If the determination in step S5 is YES, that is, if the radar sensor switch 6 is ON, it is determined whether the vehicle speed is lower than a predetermined vehicle speed V1, for example, 20 km/h (step S6). If the determination in step S6 is YES, that is, if the vehicle speed is lower than the predetermined vehicle speed V1, steps S3 and S4 are performed as in the case when the determination in step S2 is YES.

On the other hand, if the determination in step S6 is NO, that is, if the vehicle speed is equal to or higher than the predetermined vehicle speed V1, the controller unit 8 controls the display 7 not to display the own vehicle overview image and the own vehicle periphery image. Also, if the determination in step S5 is NO, that is, if it is determined that the radar sensor switch 6 is OFF, not ON, the controller unit 8 controls the display 7 not to display the own vehicle overview image and the own vehicle periphery image.

As described above, when an obstacle is detected in the own vehicle periphery in a case where the shift lever is in the backward driving range or the radar sensor switch 6 is ON with the vehicle speed being lower than the predetermined vehicle speed, the obstacle indicating line 45 is displayed depending on the detected location of the obstacle, and the displaying mode of the obstacle indicating line 45 is changed according to the distance of the obstacle.

The present embodiment describes for the vehicle periphery image display device 1 mounted on a vehicle having an automatic transmission. However, the vehicle periphery image display device according to the present embodiment can be mounted on a vehicle having a manual transmission. In such a case, a shift position sensor that detects a shift position of a change lever is provided instead of the range sensor, and it is determined whether the shift position of the change lever is in the backward driving instead of determining whether the shift lever is in the backward driving range.

As described above, in the vehicle periphery image display device 1 according to the present embodiment, the own vehicle periphery image 42 is displayed around the own vehicle overview image 41 and, when an obstacle is detected in the own vehicle periphery, the obstacle indicating line 45 indicating the detected location of the obstacle around the own vehicle and the distance between the own vehicle and the obstacle is displayed closer to the own vehicle overview image 41 than the own vehicle periphery image 42. In such a manner, the obstacle indicating line 45 is not superposed on the own vehicle periphery image 42, so that the obstacle indicating line 45 can accurately display the position and distance of the obstacle without deteriorating the visibility of the obstacle in the own vehicle periphery image 42. In a situation such as when parking the vehicle, the driver is given an accurate alert against the obstacle in the own vehicle periphery by the own vehicle periphery image 42 and the obstacle indicating line 45.

In the present embodiment, the obstacle indicating section is the obstacle indicating line 45 provided along around the own vehicle overview image 41. The displaying mode of the obstacle indicating line 45 is changed according to the distance between the own vehicle and the obstacle, so that the displaying region of the obstacle indicating line 45 can be provided smaller than the case of providing a plurality of the obstacle indicating lines outside of the own vehicle overview image according to the distance between the own vehicle and the obstacle.

Furthermore, the own vehicle periphery image 42 is displayed around the own vehicle overview image 41 with the blind area 43 (area which cannot be captured by the camera 3) which is not included in the own vehicle periphery image between the own vehicle overview image 41 and the own vehicle periphery image 42. Also, the obstacle indicating line 45 is displayed in the blind area 43 in a manner of effectively using the blind area 43 which is not included in the own vehicle periphery image 42 as the obstacle indicating section to specifically obtain the specific effect described above without deteriorating the visibility of the obstacle in the own vehicle periphery image.

Furthermore, the displaying mode of the obstacle indicating line 45 can be changed according to the distance between the own vehicle and the obstacle by changing at least one of the line type, the displaying color, and the mode of lighting or blinking of the obstacle indicating line 45, thereby indicating the distance between the own vehicle and the obstacle in a relatively easy manner.

Furthermore, when the displaying mode of the obstacle indicating line 45 is changed according to the distance between the own vehicle and the obstacle by changing the mode of lighting or blinking of the obstacle indicating line 45, the blinking frequency of the obstacle indicating line 45 is changed according to the distance between the own vehicle and the obstacle so that the driver can easily recognize the distance between the own vehicle and the obstacle.

Furthermore, with the own vehicle periphery image displayed around the own vehicle overview image when parking the vehicle, the driver is given an accurate alert against the obstacle in the own vehicle periphery by the own vehicle periphery image 42 and the obstacle indicating line 45 when parking the vehicle. This effectively supports the driver to park the vehicle.

Although the obstacle indicating line 45 is displayed along around the own vehicle overview image 41 in the blind area 43 in the first embodiment, the obstacle indicating line 45 can be displayed along around the own vehicle overview image 41 in the own vehicle overview image 41, and the displaying mode of the obstacle indicating line 45 can be changed according to the distance of the obstacle.

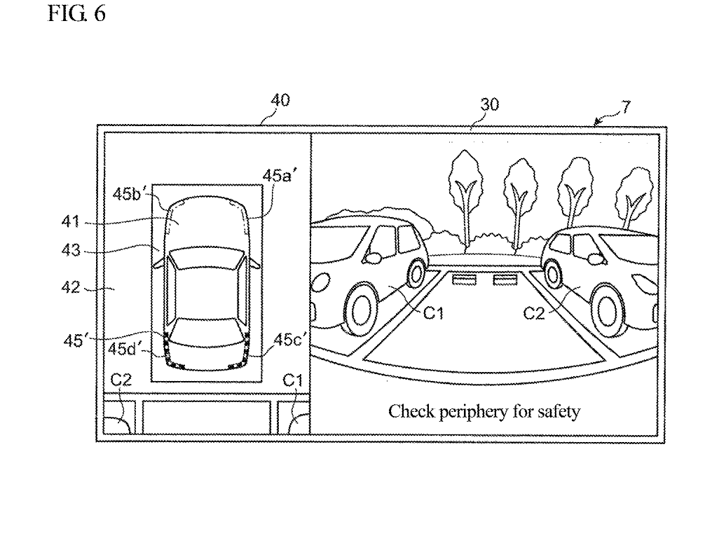

FIG. 6 is an explanatory view for explaining a display of a vehicle periphery image display device according to a second embodiment. The difference between the vehicle periphery image display device according to the second embodiment and the vehicle periphery image display device according to the first embodiment is the displayed location and displaying mode of the obstacle indicating section. A description on the configuration same as the vehicle periphery image display device of the first embodiment will be omitted.

Also in the vehicle periphery image display device according to the second embodiment, the controller unit 8 causes the display 7 to display the own vehicle periphery image around the own vehicle overview image when the range sensor 2 detects the backward driving range, and performs obstacle indication control to display, closer to the own vehicle overview image than the own vehicle periphery image, the obstacle indicating section indicating the detected location of an obstacle around the own vehicle and the distance between the own vehicle and the obstacle when the obstacle is detected in the vehicle periphery.

As shown in FIG. 6, when the range sensor 2 detects the backward driving range, the display 7 displays the own vehicle overview image 41 and the own vehicle periphery image 42 around the own vehicle overview image 41 on the left screen 40 with the blind area 43 provided between the own vehicle overview image 41 and the vehicle periphery image 42.

In the present embodiment, when an obstacle is detected in the own vehicle periphery, an obstacle indicating line 45′ is displayed, as the obstacle indicating section indicating the location and the distance of the obstacle, along around the own vehicle overview image 41 in the own vehicle overview image 41 in the own vehicle periphery.

The obstacle indicating line 45′ specifically includes a right front corner obstacle indicating line 45a′, a left front corner obstacle indicating line 45b′, a right rear corner obstacle indicating line 45c′, and a left rear corner obstacle indicating line 45d′, each of which is provided at the right front corner, the left front corner, the right rear corner, and the left rear corner around the own vehicle overview image 41.

When an obstacle is detected in the own vehicle periphery based on a signal from the radar sensor 4, an obstacle indicating line, among the obstacle indicating lines 45a′ to 45d′ constituting the obstacle indicating line 45′, that corresponds to the location of the obstacle around the own vehicle detected by the radar sensor 4 is displayed. The distance between the own vehicle and the obstacle detected by the radar sensor 4 is displayed by changing the displaying mode of the obstacle indicating line 45′ (each of the obstacle indicating lines 45a′ to 45d′).

For the obstacle indicating line 45′ displayed on the display 7 in the vehicle periphery image display device according to the second embodiment, Table 2 below shows displaying modes that are changed according to the distance between the own vehicle and the obstacle. In Table 2, each of the right front corner obstacle indicating line 45a′, the left front corner obstacle indicating line 45b′, the right rear corner obstacle indicating line 45c′, and the left rear corner obstacle indicating line 45d′ is expressed as a corner.

TABLE 2

| Ranges in which | | | Displaying color, | Lighting or |
|---|---|---|---|---|
| obstacle is detected | Corner | | line type | blinking |
| Short range | About 30 | cm | Red solid line | Lighting |
| Middle range | 30 to 45 | cm | Red broken line | Lighting |
| Long range | 45 to 55 | cm | Green solid line | Lighting |

As shown in Table 2, in the present embodiment, the obstacle indicating line 45′ indicates the distance from the obstacle by ranges in which the obstacle is detected, which are a short range, a middle range, and a long range. The obstacle indicating line 45′ is displayed as a red solid line blinking when the obstacle is detected in the short range, a red broken line blinking when the obstacle is detected in the middle range, and a green solid line blinking when the obstacle is detected in the long range.

As for the corner obstacle indicating lines 45a′, 45b′, 45c′, and 45d′, the short range is set to a distance shorter than 30 cm, the middle range is set to a distance of 30 cm or longer and shorter than 45 cm, and the long range is set to a distance of 45 cm or longer and shorter than 55 cm.

As shown in FIG. 6, when vehicles C1 and C2 are respectively present at a distance of 40 cm from the own vehicle in the right rear corner periphery and left rear corner periphery of the own vehicle when parking the vehicle, the corner obstacle indicating lines 45c′ and 45d′ are each displayed as a blinking red broken line on the left screen 40 according to the location and distance of the vehicles C1 and C2 (in FIG. 6, the broken black lines indicate the blinking red broken lines).

As shown in Table 2, the displaying mode of the obstacle indicating line 45′ to be displayed corresponding to the location and distance of the obstacle in the own vehicle periphery is preset and stored in the controller unit 8.

Also in the vehicle periphery image display device according to the second embodiment, when an obstacle is detected in the own vehicle periphery in a case where the shift lever is in the backward driving range or the radar sensor switch 6 is ON with the vehicle speed being lower than the predetermined vehicle speed, the obstacle indicating line 45′ is displayed depending on the detected location of the obstacle, and the displaying mode of the obstacle indicating line 45′ is changed according to the distance of the obstacle, in the same manner as the vehicle periphery image display device according to the first embodiment.

As described above, in the vehicle periphery image display device according to the present embodiment, when an obstacle is detected in the own vehicle periphery, the obstacle indicating line 45′ indicating the detected location of the obstacle around the own vehicle and the distance between the own vehicle and the obstacle is displayed closer to the own vehicle overview image 41 than the own vehicle periphery image 42. Accordingly, the obstacle indicating section is not superposed on the own vehicle periphery image, so that the obstacle indicating section can accurately indicate the detected location and distance of the obstacle without deteriorating the visibility of the obstacle in the own vehicle periphery image.

In the present embodiment, the obstacle indicating section is the obstacle indicating line 45′ provided along around the own vehicle overview image 41. The displaying mode of the obstacle indicating line is changed according to the distance between the own vehicle and the obstacle, so that the displaying region of the obstacle indicating line can be provided smaller than the case of providing a plurality of the obstacle indicating lines outside of the own vehicle overview image according to the distance between the own vehicle and the obstacle.

Furthermore, with the obstacle indicating line 45′ displayed in the own vehicle overview image 41 along around the own vehicle overview image 41, the effect described above can be specifically obtained without deteriorating the visibility of the obstacle in the own vehicle periphery image 42.

Although the display 7 as a display device is installed in the middle part of the dash panel in the present embodiment, a portion of a front shield or a rearview mirror can be used as a display for displaying an image.

The present invention is not limited to the embodiments described above. Various modifications and changes in design can be made without departing from the spirit and the scope of the present invention.

### INDUSTRIAL APPLICABILITY

As described above, according to the present invention, it is possible to accurately display the location and distance of an obstacle without deteriorating the visibility of the obstacle, so that the present invention may preferably be used in the technical field of manufacturing vehicles such as automobiles.

### LIST OF REFERENCE CHARACTERS

1 Vehicle periphery image display device
2 Range sensor
3, 11, 12, 13, 14 Camera
4, 21, 22, 23, 24, 25, 26 Radar
5 Vehicle speed sensor
6 Radar sensor switch
7 Display
8 Controller unit
10 Vehicle
30, 40 Screen
41 Own vehicle overview image
42 Own vehicle periphery image
43 blind area
45, 45a, 45b, 45c, 45d, 45e, 45f, 45′, 45a′, 45b′, 45c′, 45d′ obstacle indicating line

1. A vehicle periphery image display device that displays on a display screen a vehicle periphery image, comprising:
an image capturing unit that captures an own vehicle periphery image;
a display controller that causes the display screen to display an own vehicle overview image, and also displays around the own vehicle overview image the own vehicle periphery image that is captured by the image capturing unit; and
an obstacle detector that detects an obstacle in the own vehicle periphery as well as a detected location of the obstacle around the own vehicle and a distance between the own vehicle and the obstacle, wherein
the display controller displays around the own vehicle overview image the own vehicle periphery image and displays, when the obstacle detector detects an obstacle in the own vehicle periphery, an obstacle indicating section closer to the own vehicle overview image than the own vehicle periphery image, the obstacle indicating section indicating the detected location of the obstacle around the own vehicle and the distance between the own vehicle and the obstacle.

2. The vehicle periphery image display device according to claim 1, wherein
the obstacle indicating section is an obstacle indicating line provided along around the own vehicle overview image, and
the display controller changes a displaying mode of the obstacle indicating section according to the distance between the own vehicle and the obstacle.

3. The vehicle periphery image display device according to claim 2, wherein
the display controller displays the own vehicle periphery image around the own vehicle overview image with a blind area which is not included in the own vehicle periphery image captured by the image capturing unit between the own vehicle overview image and the own vehicle periphery image, and also displays the obstacle indicating line in the blind area along around the own vehicle overview image.

4. The vehicle periphery image display device according to claim 2, wherein
the display controller displays in the own vehicle overview image the obstacle indicating line along around the own vehicle overview image.

5. The vehicle periphery image display device according to claim 2, wherein
the display controller changes the displaying mode of the obstacle indicating line according to the distance between the driving vehicle and the obstacle by changing at least one of a line type, a displaying color, and a mode of lighting or blinking of the obstacle indicating line.

6. The vehicle periphery image display device according to claim 5, wherein
when the displaying mode of the obstacle indicating line is changed by changing the mode of lighting or blinking of the obstacle indicating line according to the distance between the own vehicle and the obstacle, the display controller changes a blinking frequency of the obstacle indicating line according to the distance between the own vehicle and the obstacle.

7. The vehicle periphery image display device according to claim 1, wherein
the display controller displays the own vehicle periphery image around the own vehicle overview image when parking the vehicle.
